(19) United States
(12) Patent Application Publication
(10) Pub. No.: US 2008/0245420 A1
(43) Pub. Date: Oct. 9, 2008

(54) Nozzle Attachment for Fire Hydrant

(76) Inventors: Tom Randy Davidson, Griffin, GA (US); David Michael Walden, Sharpsburg, GA (US); O. G. Sims, Williamson, GA (US); Carlos Moreno, Hampton, GA (US)

Correspondence Address: JOHN S. PRATT, ESQ;KILPATRICK STOCKTON, LLP, 1100 PEACHTREE STREET, ATLANTA, GA, 30309, US

(21) Appl. No.: 12/099,407

(22) Filed: Apr. 8, 2008

Related U.S. Application Data
(60) Provisional application No. 60/922,336, filed on Apr. 9, 2007.
(60) Provisional application No. 60/980,635, filed on Oct. 17, 2007.

(51) Int. Cl. E03B 9/02; F16L 55/00

(52) U.S. Cl. 137/296; 285/14; 29/401.1

(57) ABSTRACT

A nozzle attachment device for retrofitting fire hydrants with additional structure for reducing the potential that those with ill intent can foul municipal water supplies by introducing toxins or other materials into fire hydrants. Various embodiments include a housing with a channel and connection means for the fire hydrant's nozzle for efficient and cost effective installation, a seat and a valve within the channel which interact to close off portions of the hydrant otherwise available for receipt of toxic or other materials when the fire hydrant nozzle cap is unscrewed and open.

### CROSS REFERENCE TO RELATED APPLICATIONS

This application claims the priority of U.S. provisional application Ser. No. 60/922336, entitled “Hydrant Ecco-Terrorism Resister Orb (HERO)”, filed Apr. 9, 2007, and U.S. provisional application Ser. No. 60/980,635, entitled “Nozzle Attachment for Fire Hydrant,” filed Oct. 17, 2007, the entire contents of each of which are hereby incorporated by this reference.

### FIELD OF INVENTION

Various aspects and embodiments of the present invention relate to providing fire hydrants with additional housing and valving in order to render more difficult the task of introducing toxins into a water supply.

### BACKGROUND

Conventional fire hydrants offer access to a municipal water supply in a manner in which operatives with ill intent may appreciate. Briefly, conventional fire hydrants include at least one nozzle for coupling to a fire hose. A threaded cap closes off the nozzle when the hydrant is not in use. The hydrant also includes a hydrant valve which controls flow of water from the water supply to and through the hydrant, through the nozzle(s), and into the fire hose.

Conventionally, the barrel of the hydrant between the nozzle and the hydrant valve, which is in the lower portion of the hydrant, accommodates several gallons of fluid. Accordingly, it is possible to unscrew a nozzle cap, introduce gallons of toxin, reattach the nozzle cap and open the hydrant valve to allow the toxins to communicate with and flow by gravity and perhaps at least to some extent by Bernoulli's principle, into the municipal water supply, since when the nozzle cap is attached, water pressure from the water supply would not force the toxins back out of the hydrant.

Numerous attempts to solve this problem have been attempted. U.S. Pat. No. 6,910,495, entitled “Backflow Prevention System,” has a system within a nozzle of a hydrant that prevents outside liquids and substances from entering into the fire hydrant. However, the system cannot be added to pre-existing fire hydrants. In U.S. Pat. No. 7,240,688 entitled “Retrofitting a Fire Hydrant with Secondary Valve,” and U.S. Pat. No. 7,055,544 entitled “Fire Hydrant with Second Valve,” a system is added to an existing fire hydrant. A seat is affixed to the interior cavity of the fire hydrant using an adhesive or mechanical means while a valve structure is introduced between the nozzle and the hydrant valve, which cooperates with the seat to substantially prevent the flow of water through the valve and thus closes off portions of the hydrant barrel when a nozzle is open but the hydrant valve is closed.

While this is an effective method for installing the secondary valve, another apparatus and method is needed to prevent the infiltration of contaminants into public water systems through fire hydrants.

### SUMMARY OF INVENTION

One or more of various structures and embodiments according to the present invention includes a fire hydrant with an outer or add-on nozzle attachment including a valve in order to prevent the introduction of toxins or other substances into a water supply. Structures such as a nozzle attachment according to various embodiments of the present invention may allow for quick installation of an additional protective valve before the nozzle of the hydrant to close off the nozzle and hydrant barrel when a nozzle is open but the hydrant valve is closed. A nozzle attachment or other structure according to various embodiments of the present invention is preferably introduced at the nozzle of the fire hydrant. Such attachments may be used with dry barrel hydrants as well as wet barrel hydrants.

According to various aspects and embodiments of the present invention, the nozzle attachment may include a channel, a valve, and a valve seat. During installation, the nozzle attachment is attached to the nozzle of the fire hydrant through various methods and structures.

According to various aspects and embodiments of the present invention, a method of retrofitting a fire hydrant may include selecting a fire hydrant that has a hydrant body, disconnecting the hydrant body from the fire hydrant, providing a replacement hydrant body that has a protective valve to prevent outside liquid from entering the nozzle, and attaching the replacement hydrant body. The hydrant body may include nozzles with channels, which are associated with the protective valves to control the flow of water in and out of the nozzles.

An object of certain embodiments of the present invention is to provide structures for retrofitting fire hydrants in order to reduce the possibility of toxins being introduced into a water supply.

An additional object of certain embodiments of the present invention is to provide additional structures adapted to be installed quickly with fire hydrants in order to reduce the possibility of toxins being introduced into a water supply.

An additional object of certain embodiments of the present invention is to provide a manner that prevents fire hydrants and additional structures from damage due to water freezing within their respective channels.

An additional object of certain embodiments of the present invention is to provide a method of retrofitting fire hydrants with tampering prevention structures.

Other objects, features, and advantages of various embodiments of the present invention will become apparent with respect to the remainder of this document.

### BRIEF DESCRIPTION OF THE DRAWINGS

FIG. 1 shows a cross sectional view of a conventional fire hydrant with a nozzle cap removed and hydrant valve closed.

FIG. 2 shows toxins being introduced into the nozzle of the hydrant of FIG. 1.

FIG. 3 shows the cap replaced on the nozzle of the hydrant of FIG. 1 after toxins have been introduced.

FIG. 4 shows the opening of the hydrant valve to introduce toxins into a water supply as a result of the sequence shown in FIGS. 1-3.

FIG. 5 shows a cross-sectional view of a nozzle attachment according to one embodiment of the present invention.

FIG. 6 shows a perspective view of a nozzle attachment according to one embodiment of the present invention.

FIG. 7 shows a front view of the nozzle attachment of FIG. 8.

FIG. 8 shows a cross-sectional view of a fire hose connected to the nozzle attachment of FIG. 5.

FIG. 9 shows a cross-sectional view of a fire hydrant with the nozzle attachment of FIG. 5.

FIG. 10 shows a cross-sectional view of a fire hydrant with an offset actuator rod and a nozzle attachment according to one embodiment of the present invention.

FIG. 11 shows a cross-sectional view of a nozzle attachment according to one embodiment of the present invention.

FIG. 12 shows a perspective view of a nozzle attachment with its housing transparent according to one embodiment of the present invention.

FIG. 13 shows a perspective view of the nozzle attachment of FIG. 12 with its housing transparent.

FIG. 14 shows a cross-sectional view of the nozzle attachment of FIG. 11 attached to a fire hydrant.

FIG. 15 shows a cross-sectional view of a nozzle attachment according to one embodiment of the present invention.

FIG. 16 shows a perspective view of the nozzle attachment of FIG. 15 with its housing transparent.

FIG. 17 shows a perspective view of the nozzle attachment of FIG. 15 with its housing transparent.

FIG. 18 is a flow chart illustrating one method for retrofitting a fire hydrant with a tampering prevention device.

### DETAILED DESCRIPTION

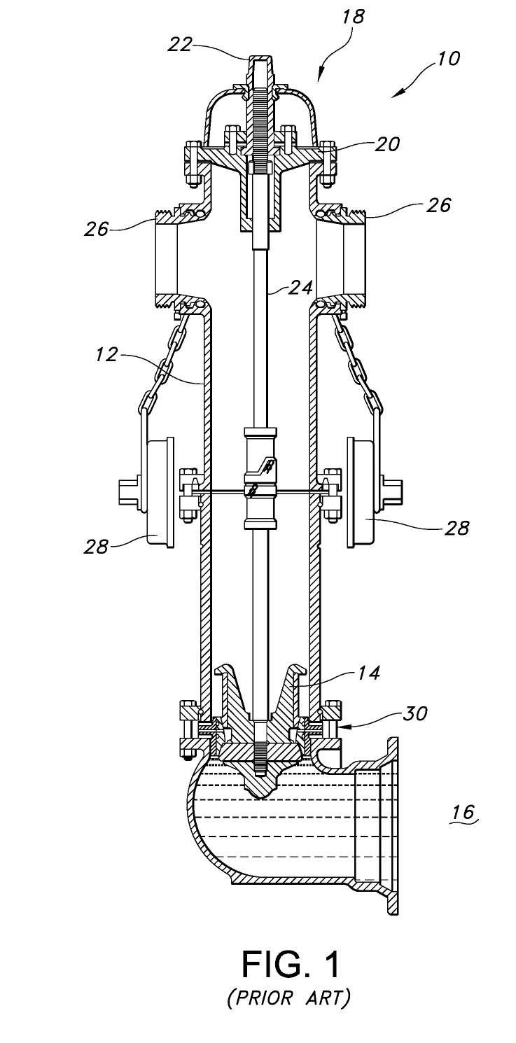

FIG. 1 shows a conventional dry barrel fire hydrant 10. The hydrant 10 typically includes a substantially vertical barrel 12 through which water may flow from a water main to a fire hose given certain circumstances as discussed generally below. At one end of the barrel 12 is a hydrant valve 14, which controllably interrupts fluid flow between a water supply 16 and the barrel 12. At the upper end of the barrel 12 may be found a cap structure 18 which can include, for instance, a housing cover 20 and an operating nut 22 which rotates within the housing cover 20. The operating nut 22 includes threads, which receive threads on an actuator rod 24, which in turn connects to the hydrant valve 14. Not only does the cap structure 18 seal the top portion of the barrel 12 to prevent the flow of water, but operating nut 22 may be used by fire fighters or others to open the hydrant valve 14 via actuator rod 24. Hydrant 10 includes at least one nozzle 26 and can include more nozzles 26. The nozzles 26 may have threads on their ends in order to secure a fire hose or other connecting device. Each nozzle 26 may be closed with a cap 28 which may be threaded as well when no hose is attached. The hydrant may also include breakaway structure such as a traffic feature 30.

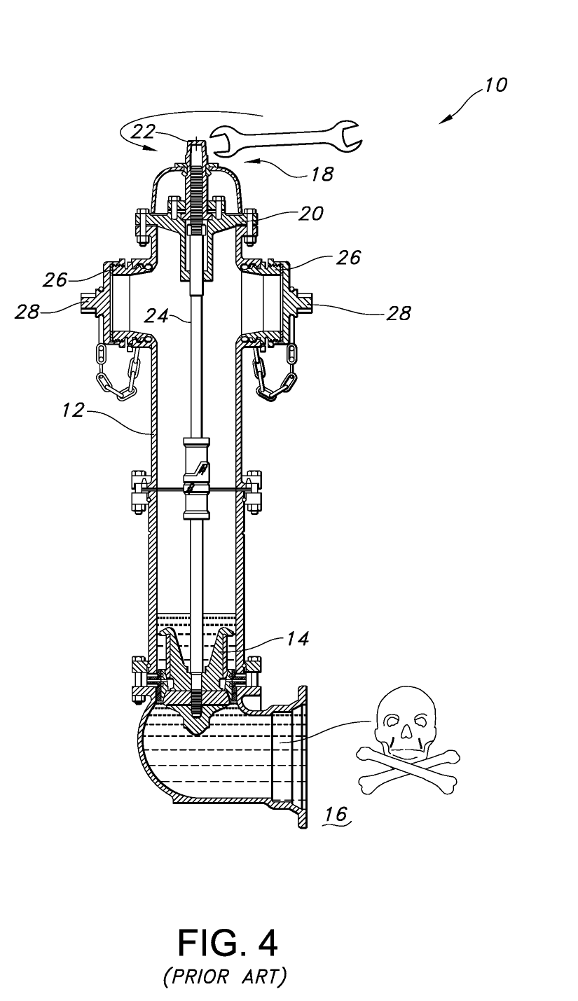

In normal operation, the hydrant 10 may be employed as follows to help fight fires, provide refreshing summer breaks for overheated urban citizens and/or their offspring, participants in road races, or for other purposes or beneficiaries. First, a hose (not shown) may be connected to nozzle 26, usually in a threaded fashion after the cap 28 has been removed (See, e.g., FIG. 1). Then, after the hose is connected, the operating nut 22 may be rotated with a wrench to cause the actuator rod 24 to push down on relevant portions of the hydrant valve 14 in order to open the hydrant valve 14 (See, e.g., FIG. 4). When the valve 14 opens, water flows from the water supply 16 through the hydrant valve 14 through the barrel 12, out the nozzle 26 into the hose and accordingly toward its desired application or destination.

A wet barrel fire hydrant (not shown), as described in U.S. patent application Ser. No. 11/544,429, entitled Wet Barrel Fire Hydrant System with Second Valve, has many of the same elements of the dry-barrel fire hydrant disclosed above. However, the valve preventing water from exiting the hydrant is located between the nozzle exit and the barrel. As such, the barrel of the fire hydrant retains water when the hydrant is not in use. When the nozzle valve opens, water flows from the barrel, provided by the water supply, out the nozzle.

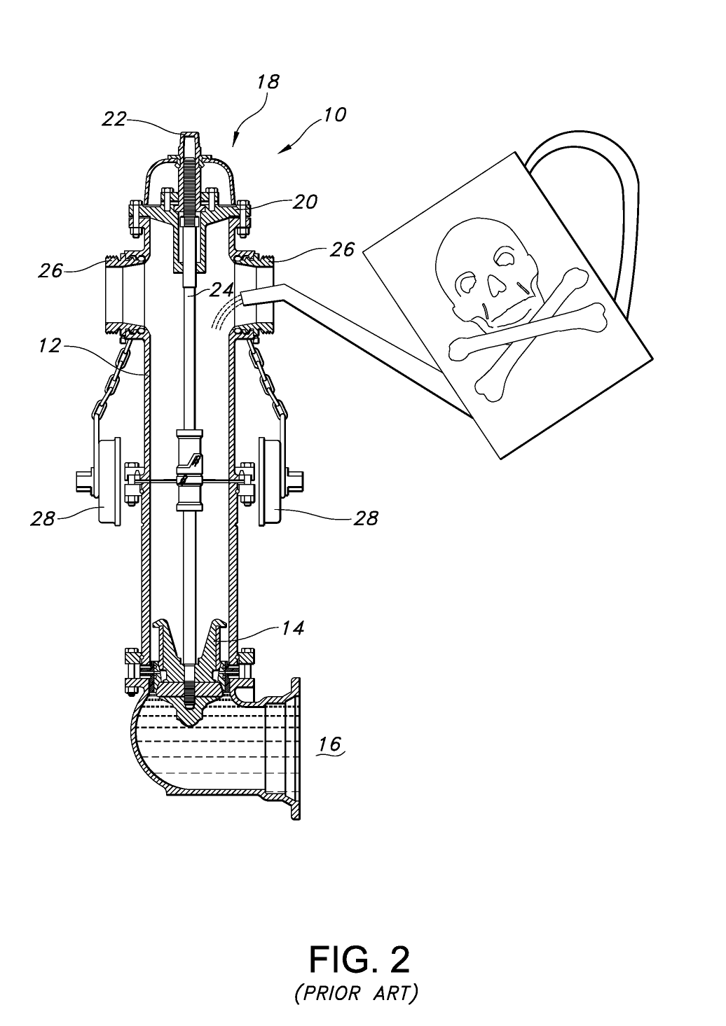

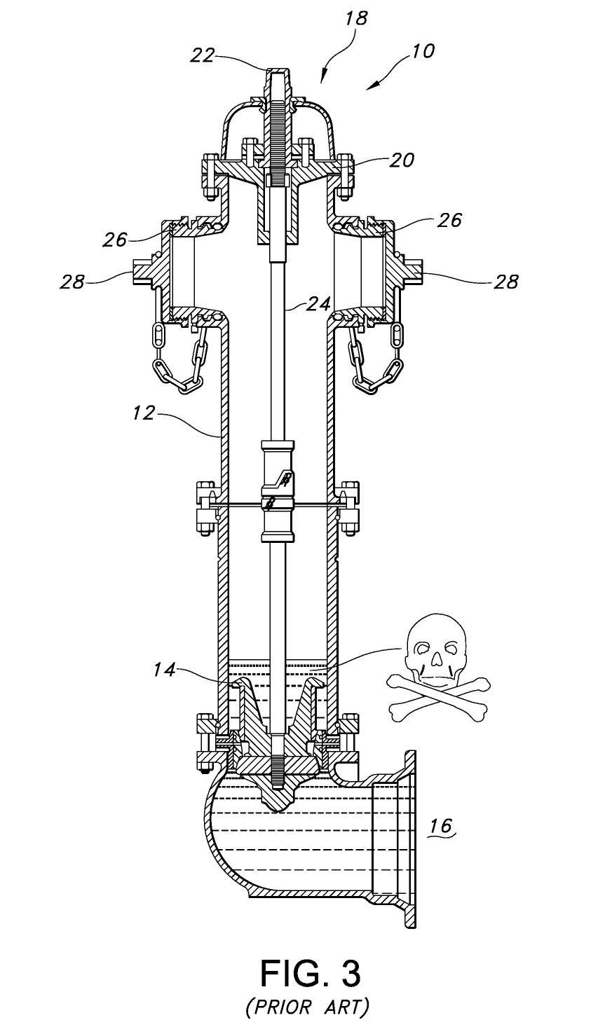

Both wet barrel fire hydrants and dry barrel fire hydrants 10 may be the subject of attention from miscreants who have the temerity to attempt to introduce toxins into a public water supply. Such concerns have heightened since the date known as “9-11” (Sep. 11, 2001) when terrorist activities became the focus of heightened concern. Accordingly, the need for structures according to various embodiments of the present invention became more apparent after that bellwether event, even if they were foreseen by the inventor named in this document beforehand. More particularly, a person with ill design can attempt to introduce toxins into a water supply 16 taking advantage of the fact that the barrel 12 of a hydrant 10 between the nozzle 26 and the hydrant valve 14 can accommodate several gallons of liquid or solid material (a wet barrel hydrant does not provide the same volume accommodation as a dry barrel hydrant, but nevertheless provides space for toxins). Accordingly, as shown in FIGS. 1-4, a malefactor can unscrew cap 28 as shown in FIG. 1, introduce toxins as shown in FIG. 2, screw the cap back on as shown in FIG. 3, and open the hydrant valve 14 as shown in FIG. 4. When the nozzle 26 or all nozzles 26 are closed off and the valve 14 opened, the liquid or solid toxins in the barrel 12 can communicate with liquid in the water supply 16 in order to foul the water supply 16 to the potential detriment of all those whose facilities are in communication with such water supply 16.

Various structures according to certain embodiments of the present invention prevent or reduce the possibility of such unworthy and direct reprobatory activity. Generally, various structures may introduce physical structures before the nozzle 26 through which water flows only when a nozzle 26 and water-interrupting valve are open. Alternatively, or in combination, such structures may close off portions of the nozzle 26 in order to deprive miscreants of at least a portion, if not all, of the space available into which to load toxins before closing the nozzle 26 and opening the valve 14.

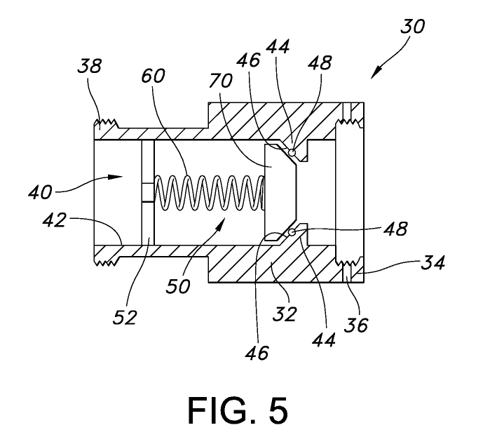

FIG. 5 shows a nozzle attachment 30 according to one embodiment of the present invention. The nozzle attachment 30 can include a housing 32 made of similar material as a fire hydrant's barrel, such as cast iron, or alternatively made from any metal or rigid material that provides the necessary strength to withstand the relatively high internal water pressure when necessary and to withstand varying external climate changes for a long period of time. The nozzle attachment 30 has a nozzle connecting end 34 that can be coupled to a nozzle of a fire hydrant, including a steamer port of a hydrant. The nozzle connecting end 34 may also house a locking mechanism 36, which is discussed in more detail below. In some embodiments, the nozzle connecting end 34 may have a swivel coupling extension, allowing the nozzle attachment 30 to be rotated while attached to the nozzle of a fire hydrant. The nozzle attachment 30 has a hose receiving end 38 opposite the nozzle connecting end 34. The hose receiving end 38 may receive a fire hose or a cap.

The housing 32 of the nozzle attachment 30 forms a channel 40 that runs from the nozzle connecting end 34 to the hose receiving end 38. The channel 40 is similar to the channel that runs through the hydrant's barrel 12, extending the passageway for water to exit from a hydrant when the nozzle attachment 30 is attached. An inner surface 42 forms the boundary for the channel 40. Extending from the inner surface 42 is a seat 44. The seat 44 may be an extension of the housing 32, and can be made from similar material. The seat 44 is essentially circular or otherwise configured in a similar shape as the housing 42, and forms a ledge 46 within the channel 40. In one embodiment, a recessed o-ring or quad ring 48 may reside within a recessed groove of the ledge 46.

The structure of the nozzle attachment 30 prevents toxins and/or other liquids or solutions from entering the hydrant 10 while allowing water to exit the hydrant when needed without manual control. In order to prevent outside substances, such as toxins, from entering a fire hydrant, the seat 44 engages a valve 50 that closes the channel 40 of the nozzle attachment 30, but allows water to flow out the hose receiving end 38 when a hydrant's main valve 14 is opened. The valve 50 includes an anchor 52, a biasing member 60, and a stopper 70. The biasing member 60 forces the stopper 70 against the seat 46, creating a seal. When the valve 14 of the hydrant 10 is opened, the water pressure exerts a force against a front surface of the stopper 70 that is greater than that of the force applied by the biasing member 60, and pushes the stopper 70 in a direction parallel to that of the inner channel 40 away from the seat 44. As such, the seal between the stopper 70 and the seat 44 is broken, and water flows from the barrel 12 through the nozzle 26 out the nozzle attachment 30. While the valve 50 is no longer creating a barrier at the nozzle 26 to prevent toxins or other foreign substances from being introduced into the hydrant 10, the water flowing outward may prevent any outside substance from entering into the hydrant 10 to the water supply 16.

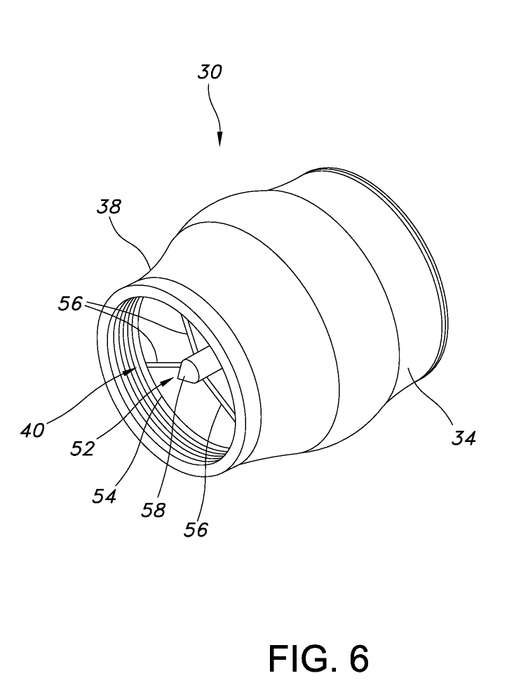

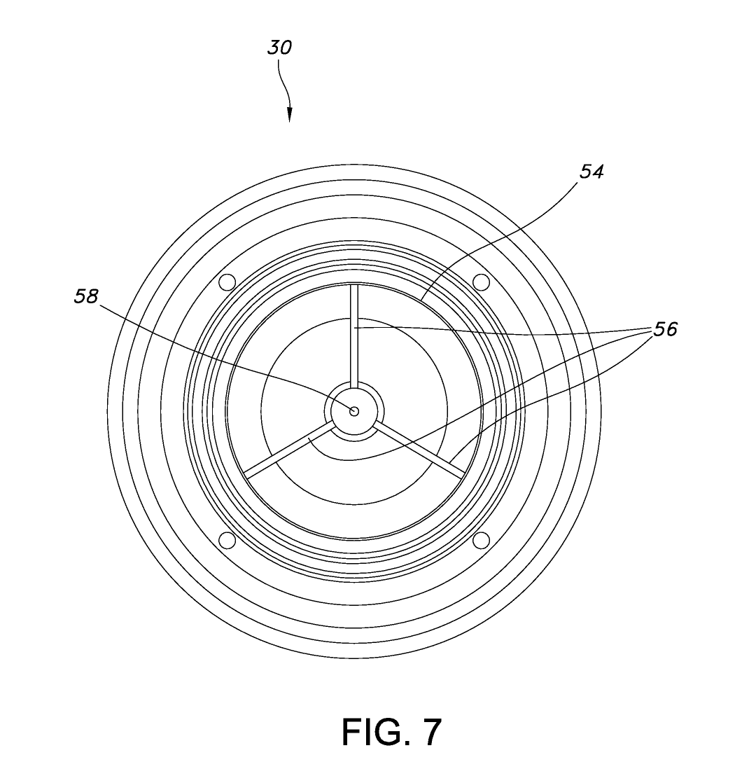

As shown in FIGS. 5-7, the anchor 52 secures the valve 50 to the inner surface 42 of the channel 40. In one embodiment, the anchor 52 has a circular portion 54 that travels around the channel 40. Spokes 56 may extend from the circular portion 54 to meet at a central point 58. This arrangement of the circular portion 54 with the spokes 56 and the central point 58 allows water to pass through the anchor 52 when the valve 50 is not engaged with the seat 46. However, other means of securing the valve 50 within the channel are available.

The central point 58 couples the biasing member 60 to the anchor 52. The biasing member 60 provides the force needed to close the channel 40 to outside toxins and substances. Examples of biasing members 60 include a spring, a compressed spring, and any resilient material shaped or formed as desired. Other mechanical energy storing devices may be used as a biasing member 60. The biasing member 60 is coupled to the stopper 70. The stopper 70 may be disc-shaped, having a circumference that is smaller than that of the channel 40 to correspond generally to the inner surface 42 of the nozzle attachment 30. In some embodiments, the stopper 70 may have a larger circumference than the inner circumference of the seat 44 in order to cooperate with the seat 44 and obstruct the flow of water and other liquids in the barrel upon certain conditions being met. In other embodiments, the stopper 70 may be rectangular, square, or any size or shape in order to cooperate with the seat 44 to obstruct the flow of water. The biasing member 60 is connected to the back of the stopper 70. A front surface of the stopper 70 may be shaped to engage the ledge 46 and the recessed ring 48, if present, of the seat 44, creating a seal to prevent backflow, specifically toxins, from entering into the nozzle 26 of the hydrant.

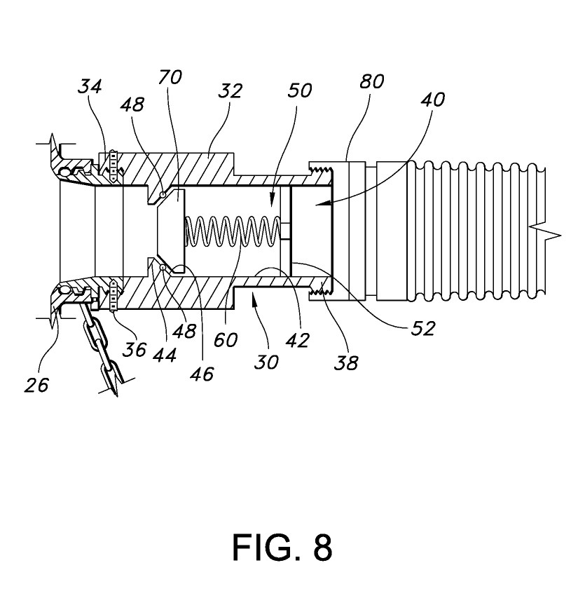

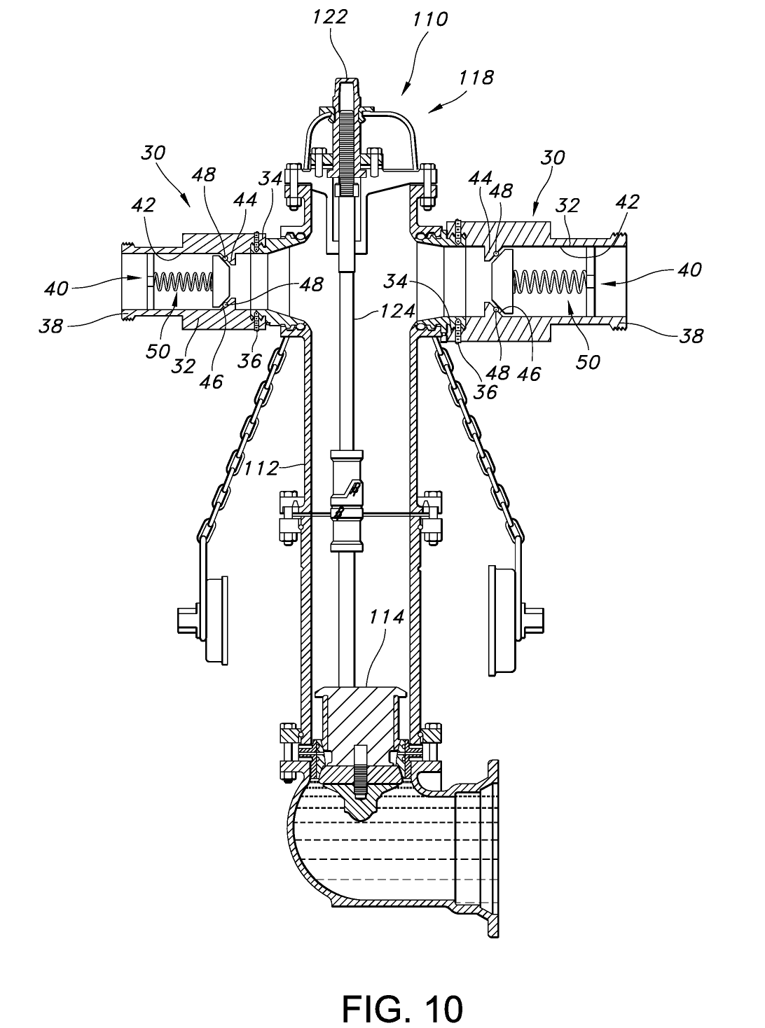

As shown in FIG. 8, a nozzle attachment 30 may be attached to a nozzle 26 of a fire hydrant 10. The nozzle attachment 30 prevents miscreants and others the opportunity to introduce toxins into the hydrant 10 and the water source 16. The nozzle attachment 30 can be attached and secured with relatively little time and effort. The nozzle attachment 30 may be retrofitted to an existing fire hydrant 10 or may be included with new fire hydrants. The nozzle attachment 30 can be coupled to the nozzle 26 of the fire hydrant 10 using the nozzle connecting end 32. A fire hose may be coupled to the fire hose receiving end 38 of the nozzle attachment 30 as shown in FIG. 10.

As shown in FIG. 10, some dry-barrel fire hydrants 110 have offset actuator rods 122. The offset actuator rod 122 may present difficulties to install a secondary valve such as those disclosed in the U.S. Pat. Nos. 7,240,688 and 7,055,544 between the primary valve 114 and the nozzle 26. Since the nozzle attachment 30 is coupled to the outside of a fire hydrant through one of its nozzles, the nozzle attachment 30 may be attached to fire hydrants having an offset actuator rod.

The nozzle attachment 30 may be coupled to the nozzle 26 of the hydrant 10 in many ways. The nozzle connecting end 34 may be threaded to match the threads on the nozzle 26 of the fire hydrant 10. However, other means of connection, such as mechanical or electromagnetic friction, may be used to connect the nozzle attachment 30 to the nozzle 26 of the fire hydrant 10. The nozzle connecting end 34 may be swivelably connected to the nozzle attachment, allowing the nozzle attachment 30 to be rotated in relation to the nozzle 26 of the fire hydrant 10. Additionally, the locking mechanism 36 of the nozzle connecting end 34 may be engaged to prevent the removal of the nozzle attachment 30 from the fire hydrant 10. In some embodiments, the nozzle connecting end 34 may be welded to secure the nozzle attachment 30 and prevent removal by the aforementioned miscreants in their attempts to introduce toxins into the water supply 16. Locking fasteners may be used as well.

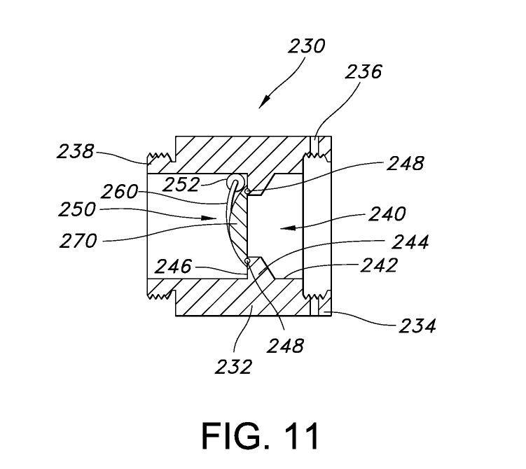

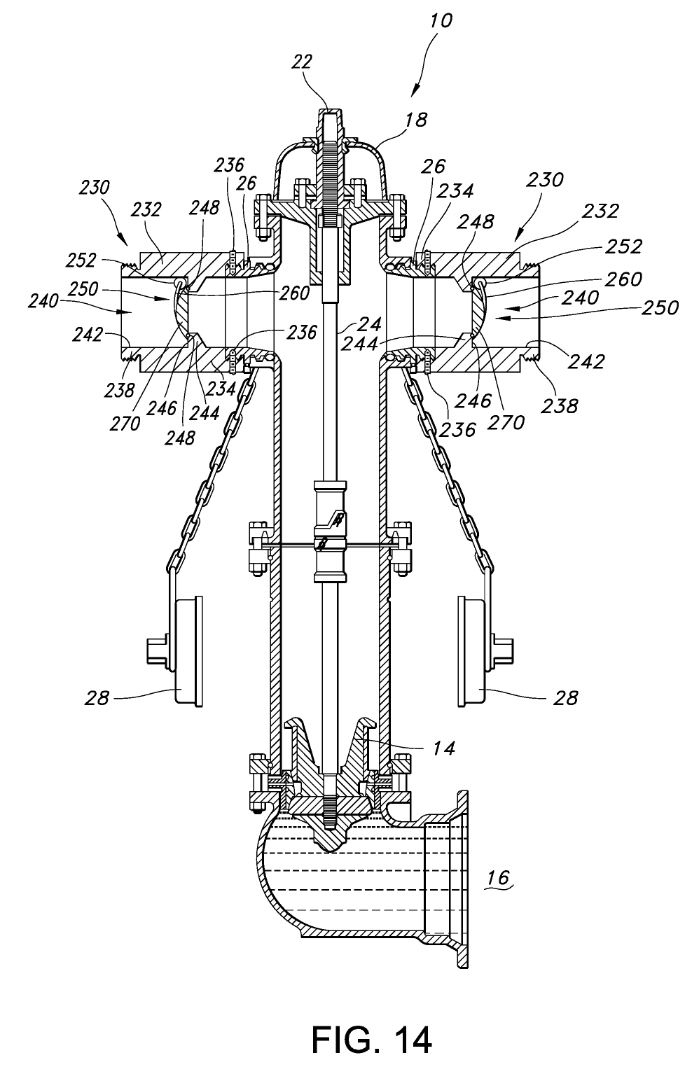

FIGS. 11-14 illustrate another embodiment of a nozzle attachment 230 according to various embodiments of this invention. The nozzle attachment 230 may be coupled to either dry or wet barrel fire hydrants. The nozzle attachment 230 may include a hinged valve 250 which prevents the introduction of toxins into the water supply 16. The nozzle attachment 230 may include some of the same elements found in the nozzle attachment 30 discussed above. The nozzle attachment 230 has a housing 232 made of similar material as a fire hydrant's barrel and a nozzle connecting end 234 that can be coupled to the nozzle 26 of the fire hydrant 10. The nozzle connecting end 234 may be threaded to match the threads on the nozzle 26 of the fire hydrant 10, and maybe swivelably associated with the nozzle attachment 230. A lock 236 may be employed to secure the nozzle attachment 230 to the hydrant. However, other means of connection, such as electromagnetic or mechanical friction connection and welding, may be used to couple the nozzle attachment 230 to the nozzle 26 of the fire hydrant 10. At the other end of the nozzle attachment 230 is a hose receiving end 238. The hose receiving may receive a cap 28 and/or the attachment end of a fire hose.

A channel 240 runs through the nozzle attachment 230. An inner surface 242 forms the boundary of the channel 240. Extending from the inner surface 242 is a seat 244. The seat 244 may be an extension of the housing 232, and can be formed of similar material. The seat 244 is essentially circular or otherwise configured in a similar shape as the housing 242, and forms a ledge 246 within the channel 240. In one embodiment, a recessed o-ring or quad ring 248 may reside within a recessed groove of the ledge 246.

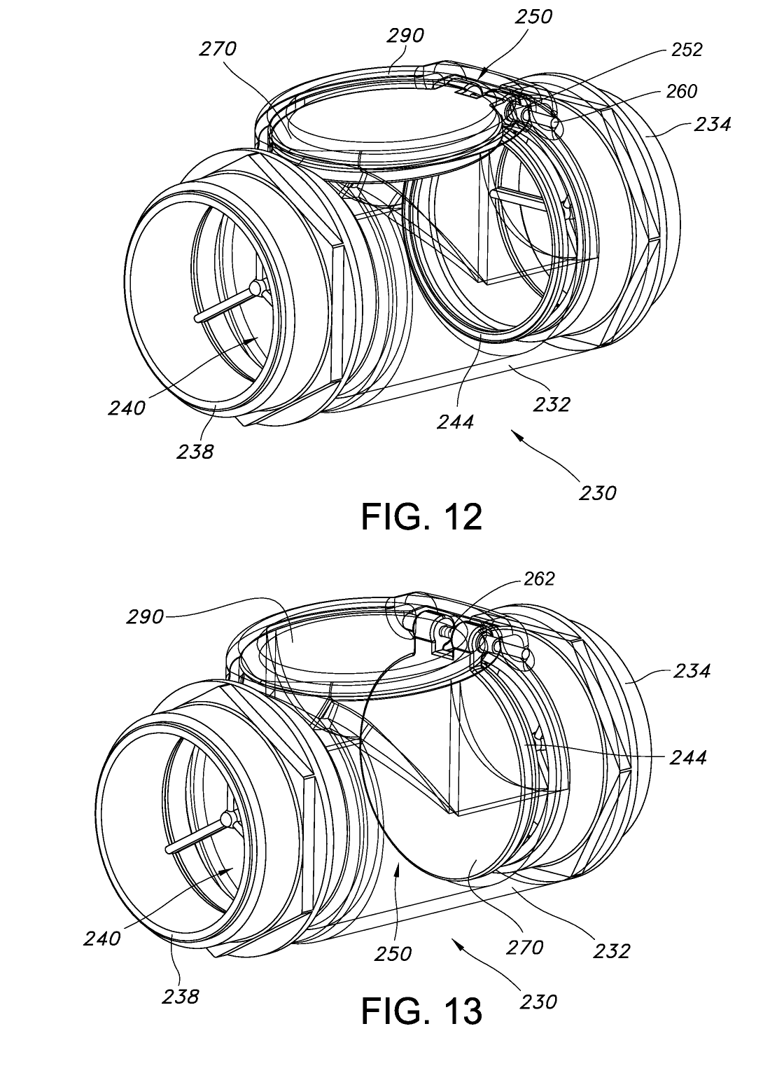

The structure of the nozzle attachment 230 prevents toxins and/or other liquids or solutions from entering the hydrant 10 while allowing water to exit the hydrant when needed without any manual control. In order to prevent outside liquids, especially toxins, from entering a fire hydrant, the seat 244 engages a hinged valve 250 that closes the channel 240 of the nozzle attachment 230, but allows water to flow out the hose receiving end 238 when a hydrant's water-interrupting valve is opened. The hinged valve 250 provides the same function as the valve 50 of the nozzle attachment 30 discussed above. As shown in FIG. 11, the hinged valve 250 includes an anchor 252, a connector 260, and a stopper 270. As shown in FIGS. 12 and 13, the anchor may include a hinge 252, which is located at the top of the inner channel 240. Gravity can apply a force against the stopper 270, pressing a front surface of the stopper 270 against the seat 244 to create a seal. However, a biasing member 262, as shown in FIGS. 12 and 13, may be used in conjunction with the connector 260 to apply a force against the stopper 270. When the hydrant's water-interrupting valve 250 is opened, the water pressure created is greater than the force applied by gravity alone or in combination with a biasing member 262. As such, the stopper 270 is pivotably moved within the channel 242 away from the seat 244, breaking the seal. The channel 240 may have a recess 290, as shown in FIGS. 12-13, that can receive the stopper 270 of the hinged valve 250 when the water pressure is applied against the stopper 270 to break the seal. The recess 290 allows the hinged valve 250 to rotate clear of the channel 240 and create a clear path for which the water to travel out of the nozzle attachment 230 when the hydrant is activated.

The hinged valve 250 is anchored by a hinge 252 that is attached to the inner surface 242 of the nozzle attachment 230. As shown in FIG. 11, the connector 260 may extend from the hinge 252 and be coupled to the stopper 270. However, as shown in FIGS. 12-13, the connector 260 may be a pin that secures the hinge valve 250. Also, the connector 260 may support a biasing member 262. Examples of biasing members 262 include, but are not limited to, a spring, a torsion spring, and any form of resilient material shaped or formed as desired. When employed by the nozzle attachment, the biasing member 262 engages a back surface of the stopper 270. The front surface of the stopper 270 engages the ledge 246 of the seat 244 to form a seal. An o-ring or a quad ring 248 may be used in conjunction with the seat 244 and the stopper 270 to further ensure a seal. The seal prevents outside liquids and substances from entering the nozzle 26 of the hydrant, and therefore the attached water supply 16.

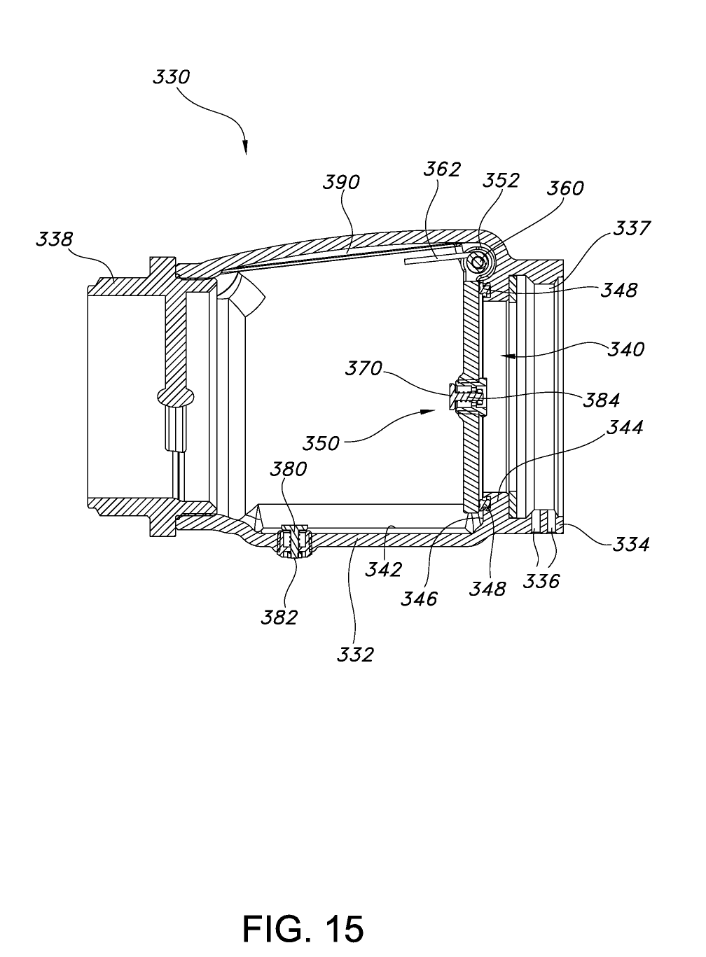

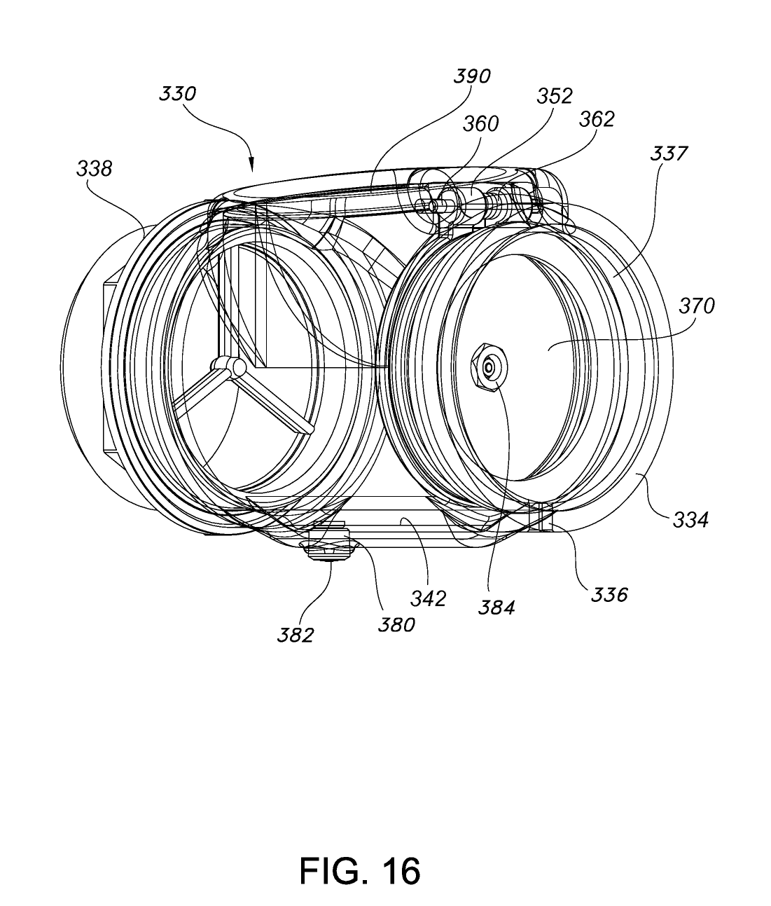

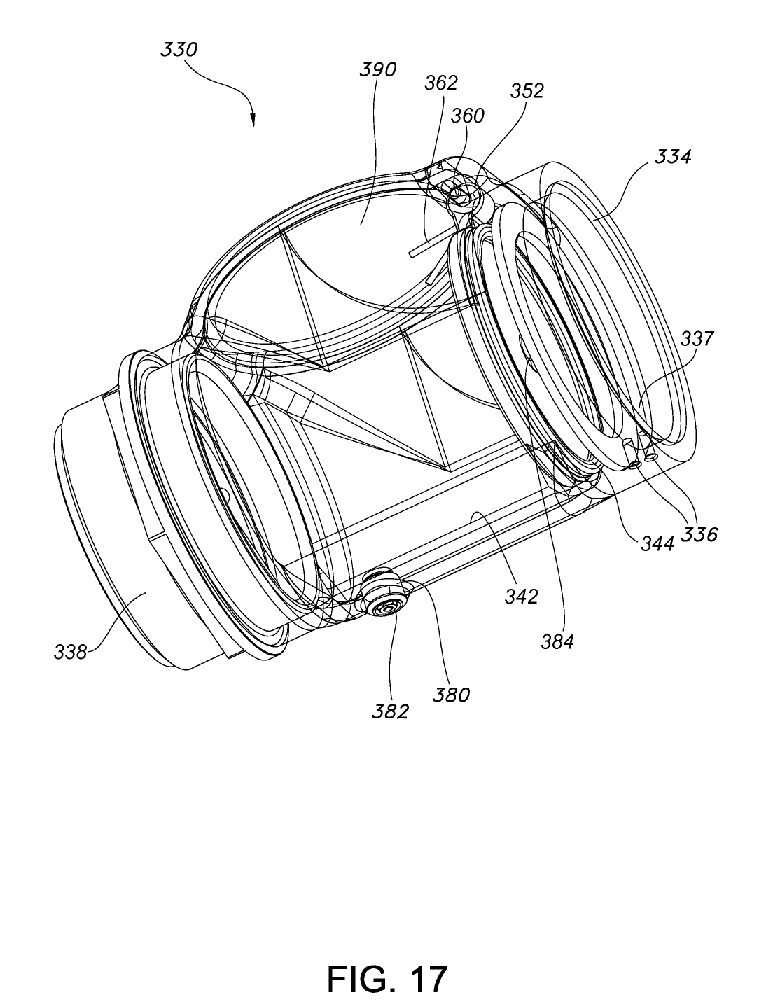

FIGS. 15-17 illustrate another embodiment of the nozzle attachment 330 according to various embodiments of the present invention. The nozzle attachment 330 shown in FIGS. 15-17 has many of the same features as those of the nozzle attachment shown 230 in FIGS. 11-14, including a hinged valve 350. The nozzle attachment 330 has a housing 332 made of similar material as a fire hydrant's barrel and a nozzle connecting end 334 that can be coupled to the nozzle 26 of the fire hydrant 10. The connecting end 334 may be threaded to match the threads on the nozzle 26 of the fire hydrant 10. The nozzle attachment 330 may be locked into place on the fire hydrant through the use of securing devices. An example, as shown in FIG. 16, are apertures 336 for locking screws, which engage the nozzle of a hydrant while securing the nozzle attachment 330. However, other means of connection, such as electromagnetic or mechanical friction connection and welding, may be used to couple the nozzle attachment 330 to a nozzle of a fire hydrant. Also, the connecting end 334 may have a swivel coupling device 337 that allows the nozzle attachment 330 to be secured to a fire hydrant nozzle while being able to rotate the attachment 330, which will be discussed further below. At the other end of the nozzle attachment 330 is a hose receiving end 338. The hose receiving may receive a cap and/or an attachment end of a fire hose.

A channel 340 runs through the nozzle attachment 330, with an inner surface 342 forming its boundary. Extending from the inner surface 342 is a seat 344, which may be an extension of the housing 332, and can be made of similar material. The seat 344 is essentially circular or otherwise configured in a similar shape as the housing 342, and forms a ledge 346 within the channel 340. The seat 344 engages a hinged valve 350 that closes the channel 340 of the nozzle attachment 330, preventing outside liquids from entering the hydrant while allowing water to flow out the hose receiving end 338 when a hydrant's water-interrupting valve is opened. A recessed o-ring or quad ring 348 may reside within a recessed groove of the ledge 346 to further assist in forming a seal.

The hinged valve 350 may operate in the same manners as that of the hinged valve 250 discussed above. As shown in FIGS. 15-17, the hinged valve 350 includes an anchor 352, a connector 360, and a stopper 370. The anchor may include a hinge 352, which is located at the top of the inner channel 340. Gravity can apply a force against the stopper 370, pressing a front surface of the stopper 370 against the seat 344 to create a seal. However, a biasing member 362 may be used in conjunction with the connector 360 to apply a force against the stopper 370. When the hydrant's water-interrupting valve is opened, the water pressure created is greater than the force applied by gravity or the biasing member 362. As such, the stopper 370 is pivotably moved within the channel 342 away from the seat 344, breaking the seal. The channel 340 may have a recess 390 that can receive the stopper 370 of the hinged valve 350 when the water pressure is applied against the stopper 370 to break the seal. The recess 390 allows the hinged valve 350 to rotate clear of the channel 340 and create a clear path for which the water to travel out of the nozzle attachment 330 when the hydrant is activated.

The hinged valve 350 may be anchored by a hinge 352 that is attached to the inner surface 342 of the nozzle attachment 330. As shown in FIGS. 15-17, the connector 360 may be a pin that secures the hinge valve 350. However, the connector 360 may extend from the hinge 352 and be coupled to the stopper 370. Also, the connector 360 may support a biasing member 362, which may engage the back surface of the stopper 370 applying a force so that the stopper 370 engages the ledge 346 of the seat 344, forming a seal.

The nozzle attachment 330 may also have means to prevent water from freezing within itself and the fire hydrant as well. After use of a fire hydrant, it is common for caps to be replaced on the hydrant nozzle while water is still present, creating a freezing issue, which can damage the hydrant. As shown in FIGS. 15-17, the housing 342 of the nozzle attachment 330 may include a second channel 380 equipped with a check valve 382. A weeping hole 384 may be found in the stopper 370 of the hinged valve 350. The channel 380, the check valve 382, and weeping hole 384 operate together in a fashion to ensure that water can be drained from the nozzle attachment 330 after operation of the hydrant. Water trapped within the nozzle attachment 330 may still exit through the second channel 380 and check valve 382 even with nozzle caps attached. Additionally, water trapped within the hydrant's body may escape through the weeping hole 384, and then exit through the second channel 380 and check valve 382. Additionally, the swivel coupling device 337 ensures that the second channel 380 and check valve 382 are aligned in a manner to allow any trapped water to drain.

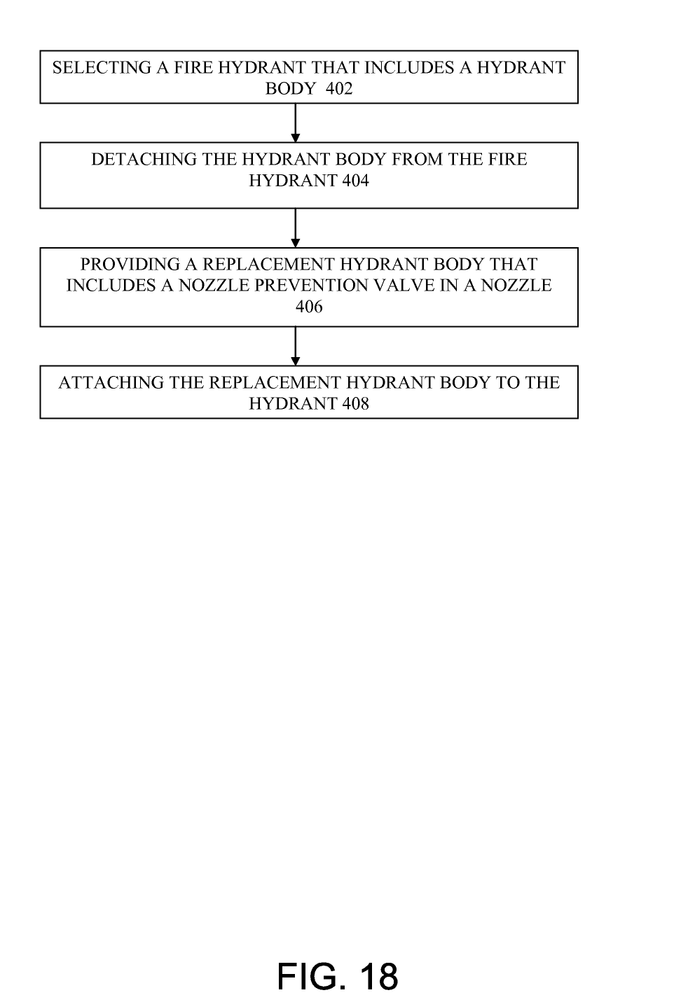

Various methods according to various embodiments of the present invention can be used to retrofit a fire hydrant. FIG. 18 illustrates one embodiment of a method to retrofit a fire hydrant.

In block 402, a fire hydrant is selected. The fire hydrant has a hydrant body and a nozzle, where the hydrant body may be connected to the hydrant at a breakaway structure. The breakaway structure may be connected to a water conduit. The water conduit is connected to a water source. The fire hydrant may also have a detachable bonnet which may be removably connected to the hydrant body.

In block 404, the hydrant body is detached from the hydrant at a breakaway structure. If the fire hydrant includes a bonnet, the hydrant body is disconnected from the bonnet as well.

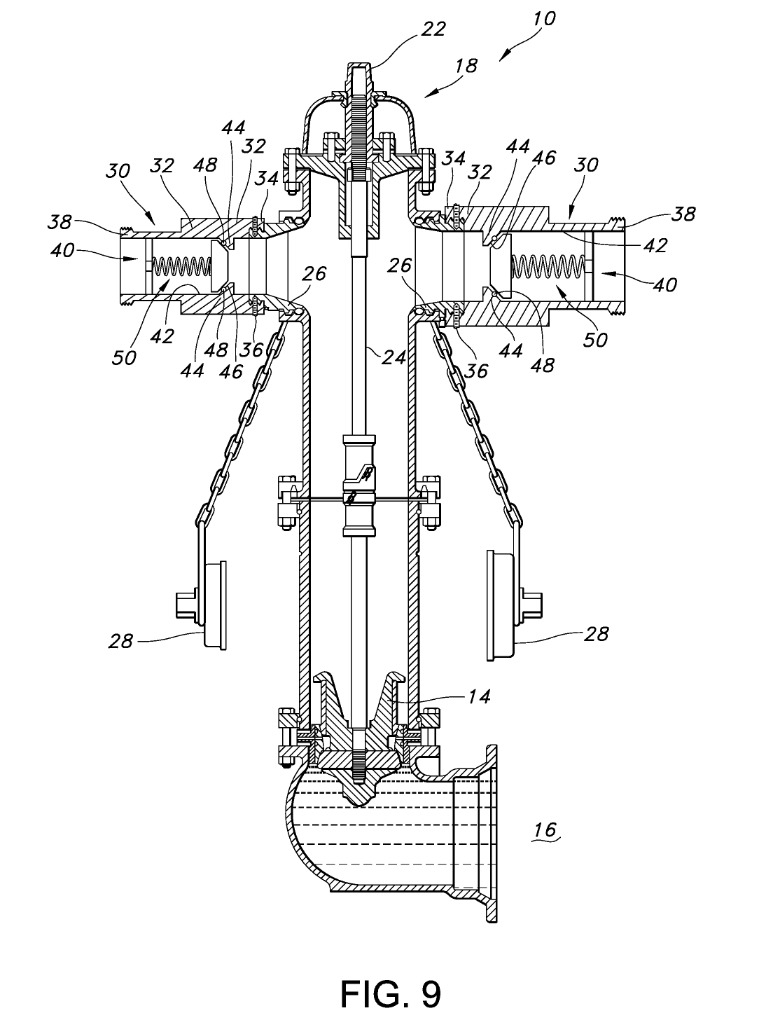

In block 406, a replacement hydrant body is provided. In one embodiment, the replacement hydrant body includes at least one nozzle and a nozzle prevention valve that prevents outside liquids from entering the nozzle while allowing liquids to flow through and exit the nozzle. The nozzle prevention valve may be located within a first channel with the nozzle of the replacement hydrant body. However, in some embodiments, the nozzle prevention valve may be located within a nozzle attachment, similar to those shown in FIGS. 5-17. The nozzle prevention valve may have a stopper, an anchor, a biasing member, and a seat, the combination of which prevents liquid from entering into the replacement hydrant body from outside sources. In some embodiments, the nozzle or nozzle attachment may have a second channel that is occupied by a check valve, as shown in FIGS. 15-17.

In block 408, the replacement hydrant body is connected to the hydrant at the breakaway structure. In some embodiments, a bonnet may be connected to the replacement hydrant body. In some embodiments, the replacement hydrant body may be connected directly to the output of the water conduit.

Any desired physical structure may be employed in order to produce or preclude introduction of undesired materials into fire hydrants. Components of embodiments according to the present invention are preferably durable materials but may be of any desired material. It is conventional for many components of fire hydrants to be bronze, and at least some or all of metallic components of structures according to the various embodiments of the present invention may be formed of bronze or other conventional or even unconventional materials. For example, in some embodiments, at least some of the components, such as the valve and/or the housing may be formed from iron and dipped in or coated with a liquid material, such as rubber or plastic. Alternatively, in some embodiments, iron components may be encapsulated in SBR rubber or powder coated. Such processes may protect the iron components from corrosion or other types of decay. Such processes may also facilitate the seal between the valve and the seat, potentially obviating the need for a separate gasket.

O-rings or quad rings may be formed of conventional materials used in fire hydrants, or unconventional materials. Suitable resilient structures such as springs which may form biasing members may be formed of any desired material having requires modulus of elasticity, durability, costs, and other properties.

Modifications, adaptations, changes, deletions, and additions may be made to various embodiments of the present invention as disclosed in this document without departing from the scope or spirit of the invention.

What is claimed is:

1. A nozzle attachment apparatus for a fire hydrant, comprising:
(a) a first end adapted to be attached to a nozzle of a fire hydrant;
(b) a second end adapted to receive a nozzle cap of a fire hydrant;
(c) a first channel between the first end and the second end; and
(d) a prevention valve located in the first channel, the prevention valve adapted to allow liquid to flow through the first channel.

2. The nozzle attachment apparatus of claim 1, further comprising a seat, the seat protruding from an inner surface of the first channel.

3. The nozzle attachment apparatus of claim 2, wherein the prevention valve further comprises a stopper, the stopper being adapted to engage the seat to prevent liquid from flowing from the second end to the first end.

4. The nozzle attachment apparatus of claim 3, further comprising a second channel, the second channel connected to the first channel and containing a check valve.

5. The nozzle attachment apparatus of claim 4, wherein the stopper further comprises a weeping hole.

6. The nozzle attachment apparatus of claim 3, wherein the prevention valve further comprises an anchor, the anchor secured to an inner surface of the first channel.

7. The nozzle attachment apparatus of claim 6, wherein the tamper prevention valve further comprises a biasing member, the biasing member connecting the stopper to the anchor and applying a force to the stopper to engage the seat.

8. The nozzle attachment apparatus of claim 6, wherein the anchor further comprises a hinge, the hinge connecting the stopper to the anchor.

9. The nozzle attachment apparatus of claim 8, wherein the tamper prevention valve further comprises a biasing member, the biasing member applying a force to the stopper to engage the seat.

10. The nozzle attachment apparatus of claim 1, further comprising a locking mechanism, the locking mechanism preventing removal of the attachable nozzle from the nozzle.

11. A fire hydrant comprising:
(a) a barrel;
(b) a nozzle extending from the barrel; and
(c) a nozzle attachment coupled to the nozzle, the nozzle attachment comprising:
i. a first end coupled to the nozzle;
ii. a second end adapted to receive a nozzle cap;
iii. a first channel; and
iv. a prevention valve.

12. The fire hydrant of claim 11, wherein the prevention valve further comprises:
(a) a biasing member;
(b) an anchor, the anchor secured to an inner surface of the first channel;
(c) and a stopper; and
(d) a seat, the seat engaging the prevention valve, preventing liquid from flowing from the second end to the first end into the barrel.

13. The fire hydrant of claim 12, wherein the prevention valve further comprises a connector, the connecter connecting the stopper to the anchor.

14. The fire hydrant of claim 13, wherein the connector further comprises a biasing member, the basing member applying a force against the stopper.

15. The fire hydrant of claim 13, wherein the anchor further comprises a hinge, the connector pivotably attached to the hinge.

16. The fire hydrant of claim 12, further comprising a main valve and an actuator rod.

17. The fire hydrant of claim 12, further comprising a second channel, the second channel connected to the first channel and containing a check valve, wherein the stopper further comprises a weeping hole.

18. The method of retrofitting a fire hydrant with a nozzle attachment, comprising:
(a) selecting a fire hydrant, the fire hydrant comprising a nozzle;
(b) providing a nozzle attachment, the nozzle attachment comprising:
i. a first channel;
ii. a first end adapted to be attached to the nozzle;
iii. a second end adapted to receive a cap of a fire hydrant or an end of a hose;
iv. a seat protruding from an inner surface of the first channel; and
v. a prevention valve adapted to allow liquid to flow through the channel; and
(c) attaching the nozzle attachment to the nozzle.

19. The method of claim 18, wherein providing a nozzle attachment includes providing a nozzle attachment wherein the prevention valve further comprises a stopper, the stopper adapted to engage the seat to seal the inner channel, preventing liquid from flowing from the second end to the first end of the nozzle attachment.

20. The method of claim 19, wherein providing a nozzle attachment includes providing a nozzle attachment wherein the prevention valve further comprises:
(a) an anchor, the anchor attached to the inner surface of the channel; and
(b) a connector, the connector attached to the anchor and the stopper.

21. The method of claim 20, wherein providing a nozzle attachment includes providing a nozzle attachment wherein the connector further comprises a biasing member, the biasing member applying a force to the stopper.

22. The method of claim 21, wherein providing a nozzle attachment includes providing a nozzle attachment further comprising a second channel, the second channel connected to the first channel and containing a check valve, wherein the stopper further comprises a weeping hole.

23. The method of claim 21, wherein selecting a fire hydrant further comprises selecting a fire hydrant which has been installed in a water supply system and is in service in the system.

24. The method of claim 20, wherein attaching the nozzle attachment further comprises attaching a nozzle attachment by welding the nozzle attachment to the nozzle.

25. The method of claim 20, wherein providing a nozzle attachment further comprises providing a nozzle attachment furthering comprising a locking mechanism; and
further comprising engaging the locking mechanism after attaching the nozzle attachment.

26. The method of retrofitting a fire hydrant, comprising:
(a) selecting a fire hydrant, the fire hydrant comprising a hydrant body comprising a nozzle, the hydrant body being connected to a breakaway structure;
(b) detaching the hydrant body from the breakaway structure;
(c) providing a replacement hydrant body comprising a replacement nozzle, the replacement nozzle comprising a prevention valve, the prevention valve adapted to allow liquid to flow through the nozzle; and
(d) attaching the replacement hydrant body to the breakaway structure.

27. The method of claim 26, wherein the fire hydrant comprises a bonnet;
wherein detaching the hydrant body from the breakaway structure further comprises detaching the hydrant body from the breakaway structure and the bonnet; and
wherein attaching the replacement hydrant body to the breakaway structure further comprises attaching the new hydrant body to the breakaway structure and attaching the bonnet to the replacement hydrant body.

28. The method of claim 26, wherein providing a replacement hydrant body further comprises providing a replacement hydrant body wherein the nozzle further comprises a first channel, the nozzle prevention valve located within the first channel.

29. The method of claim 28, wherein providing a replacement hydrant body further comprises providing a replacement hydrant body wherein the nozzle further comprises a second channel, the second channel connected to the first channel and containing a check valve.

30. The method of claim 26, wherein selecting a fire hydrant further comprises selecting a fire hydrant wherein the breakaway structure is connected to a water conduit.
